(19) United States
(12) Patent Application Publication
(10) Pub. No.: US 2026/0270318 A1
(43) Pub. Date: Sep. 10, 2026

(54) APPARATUSES AND SYSTEM FOR APPLICATION FUNCTION TRIGGERED EDGE COMPUTING SERVER DISCOVERY AND CONNECTION

(71) Applicant: Nokia Technologies Oy, Espoo (FI)

(72) Inventors: Shubhranshu SINGH, Munich (DE); Laurent THIEBAUT, Massy (FR); Klaus HOFFMANN, Munich (DE)

(21) Appl. No.: 19/472,349

(22) PCT Filed: Nov. 28, 2023
(86) PCT No.: PCT/EP2023/083310

§ 371 Date: Oct. 3, 2025

Related U.S. Application Data
(60) Provisional application No. 63/494,955, filed on Apr. 7, 2023.

(51) Int. Cl. H04L 67/148

(52) U.S. Cl. CPC H04L 67/148

(57) ABSTRACT

In one embodiment, an Application Function (AF) apparatus communicates with a Session Management Function (SMF) apparatus, the AF subscribing to the SMF to receive notifications of events. The AF receives a notification from the SMF in a source data network. The notification includes an indicator of an event, and further includes an ID of a serving data network. The AF generates a request that includes a source IP address of a source edge application server and a target IP address of a target edge application server. The request is sent to a SMF to cause the mobile device to connect to the target IP address via the serving data network.

### TECHNICAL FIELD

This application relates generally to edge computing in a data network, and in particular enhancements an application function apparatus to trigger discovery and connection to an edge computing server.

### BACKGROUND

Fifth generation (5G) is a new generation of radio systems and network architecture delivering improved bandwidth over earlier generations, as well as robust, low latency connectivity and widescale machine-to-machine connectivity for the Internet of Things (IoT).

Edge Computing makes it possible to host operator and third-party services within Edge Application Servers (EAS), which are in close proximity to the point of attachment of the User Equipment (UE), such as mobile devices. The traffic destined for the EAS can be routed based on the position of the UE and the availability of the EAS close to that position. 5GS supports an Edge Hosting Environment (EHE) deployed in the Data Network (DN) beyond a Protocol Data Unit (PDU) Session Anchor User Plane Function (UPF), also called a PSA UPF. An EHE may be under the control of either the operator or 3rd parties. When deploying Edge Computing, an application service can be served by multiple Edge Application Servers, which are typically located in different sites. These servers hosting the service may utilize either a single Internet Protocol (IP) address (e.g., anycast address) or multiple IP addresses. In order to initiate the service, the UE must be aware of the IP address(es) of the Application Server(s) responsible for serving the specific service. To obtain the IP address(es) of the appropriate Edge Application Server (e.g., an Edge Application Server that is closest to the UE), the UE may perform a discovery process. This allows the traffic to be directed locally to the Edge Application Server, optimizing service latency, traffic routing path, and the user experience.

EAS discovery is the procedure by which a UE discovers the IP address(es) of a suitable Edge Application Server(s) using Domain Name System (DNS). EAS Re-discovery is the EAS Discovery procedure that takes place when the previously discovered Edge Application Server cannot be used or may have become non-optimal. In re-discovery, a data session between a UE and a first Edge Application Server, having a first IP address, is synchronized with a second Edge Application Server, having a second IP address. The UE can be redirected to the second Edge Application Server or the 5GC may reroute the traffic on behalf.

### SUMMARY

The following summary is intended to introduce the reader to various aspects of the detailed description, but not to define or delimit any singular embodiment.

In at least one broad aspect, there is provided an apparatus, comprising: at least one processor and at least one memory storing instructions. The at least one memory and the instructions configured to, with the at least one processor, cause the apparatus at least to perform: receiving a notification from a session management apparatus in a source data network, the notification comprising an indicator of an event and an ID of a serving data network; after the receiving of the notification, generating a request comprising a source IP address of a source edge application computing server and a target IP address of a target edge application computing server, the source IP address associated with the source data network and the target IP address associated with the serving data network; and transmitting the request, the request configured to cause a data connection of user equipment to connect to the target IP address via the serving data network.

In some cases, the serving data network is different from the source data network.

In some cases, the event comprises a detection of the user equipment having changed from the source data network to the serving data network.

In some cases, the serving data network is the source data network.

In some cases, the event comprises a detection of the user equipment having disconnected from the serving data network and reconnected to the serving data network.

In some cases, the event further comprises a determination that a data offload is allowed for a user data connection in the serving data network

In some cases, the at least one memory and the instructions are configured to, with the at least one processor, further cause the apparatus at least to perform: after the receiving the notification and before the generating the request, selecting the target IP address of the target edge application computing server.

In some cases, the notification further comprises one or more candidate Data Network Access Identifier (DNAI) values associated with and combined with the ID of the serving data network, the one or more candidate DNAI values being available for the user equipment in the serving data network, and wherein the at least one memory and the instructions are configured to, with the at least one processor, further cause the apparatus at least to perform: accessing a database that stores a plurality of IP addresses reachable from the serving data network and corresponding to a plurality of edge application computing servers, the plurality of IP addresses including the target IP address; and, wherein the selecting comprises obtaining the target IP address from the database.

In some cases, the at least one memory and the instructions are configured to, with the at least one processor, further cause the apparatus at least to perform: subscribing to the serving data network to receive the notification which comprises the one or more candidate DNAI values.

In some cases, the at least one memory and the instructions are configured to, with the at least one processor, further cause the apparatus at least to perform: determining one or more candidate IP addresses corresponding to one or more candidate edge application computing servers, the one or more candidate IP addresses corresponding to the one or more candidate DNAI values; and selecting the target IP address from the one or more candidate IP addresses according to one or more parameters, wherein the one or more candidate IP addresses are a subset of the plurality of IP addresses in the database.

In some cases, the one or more parameters comprise a distance between a location of the target IP address and a location of the serving data network.

In some cases, the database is stored on the apparatus.

In some cases, the at least one memory and the instructions are configured to, with the at least one processor, further cause the apparatus at least to perform: prior to the receiving the notification, subscribing to the session management apparatus in the source data network to receive one or more notifications in response to detecting the event.

In some cases, the notification further comprises one or more Data Network Access Identifier (DNAI) values associated with and combined with the ID of the serving data network.

In another broad aspect, there is provided an apparatus, comprising: at least one processor and at least one memory storing instructions. The at least one memory and the instructions configured to, with the at least one processor, cause the apparatus at least to perform: detecting an event associated with a user equipment in a source data network; responsive to detecting the event, generating a notification, the notification comprising an indicator associated with the event and an ID of a serving data network; and transmitting the notification to an application apparatus in the source data network.

In some cases, the notification further comprises an ID of the source data network.

In some cases, the serving data network is different from the source data network.

In some cases, the event comprises a detection of the user equipment having changed from the source data network to the serving data network.

In some cases, the serving data network is the source data network.

In some cases, the event comprises a detection of the user equipment having disconnected from the serving data network and reconnected to the serving data network.

In some cases, the notification is sent after having checked that a data offload is allowed for a user data connection in the serving data network.

In some cases, the notification further comprises one or more candidate Data Network Access Identifier (DNAI) values associated with and combined with the ID of the serving data network, the one or more candidate DNAI values being available for the user equipment in the serving data network In some cases, the notification further comprises one or more Data Network Access Identifier (DNAI) values associated with and combined with the ID of the serving data network.

In some cases, the at least one memory and the instructions are configured to, with the at least one processor, further cause the apparatus at least to perform: after the transmitting the notification, receiving a message, the message configured to cause a data connection for a session serving an application of the user equipment to change from connecting via a source IP address of a source edge application computing server to connecting via a target IP address.

In some cases, the at least one memory and the instructions are configured to, with the at least one processor, further cause the apparatus at least to perform: prior to the detecting the event, subscribing the application apparatus to receive one or more notifications for the event.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example mobile communication system in accordance with some embodiments;

FIG. 2 is a block diagram of a computer in accordance with at least some embodiments;

FIG. 3 illustrates a session management function procedure in accordance with some embodiments;

FIG. 4 illustrates an application function procedure in accordance with some embodiment;

FIG. 5 illustrates a notification procedure between a session management function and an application function in accordance with some embodiments;

FIG. 6 illustrates an application function influence procedure in accordance with some embodiments; and FIG. 7 illustrates a relocation procedure in accordance with some embodiments.

### DETAILED DESCRIPTION

In a 5GS system, an Application Function (AF) manages one or more applications running that can be deployed in multiple Edge Application Servers (EAS) at different locations and which can be data connected with via different data networks. For example, the data networks may be Public Land Mobile Networks (PLMNs), and different locations may have different PLMNs. The AF typically influences the data connection

More particularly, the AF is a control plane function within a data network, such as the 5G core network, and the AF provides application services to the subscriber. For example, an application service can be a video streaming service. In an example embodiment, if an AF is trusted it can interact directly with 5GC network functions. In another example embodiment, if the AF is a 3rd party, then it may interact with an NEF. The AF can influence traffic routing, network exposure, and other network interactions for an application service.

In an example operation, a UE connects to an Edge Application Server, which has an IP address, over a data network, to access an application service facilitated by the Edge Application Server. An event occurs that may change the situation of the UE or the Edge Application Server. For example, an event may include the UE changing from the current data network to a new data network, which in some cases is called data roaming. In another example of an event, the UE disconnects from the data network, and at a later time reconnects to the same data network. In another example of an event, the current Edge Application Server is adversely affected. In another example of an event, a data connection between the UE and the current Edge Application Server is adversely affected. In other words, one or more events could trigger a discovery or re-discovery of the Edge Application Server.

Conventionally, in home routed roaming scenarios, the AF does not know about a potential target Data Network Access Identifier (DNAI) in a current data network (e.g., a home PLMN) or a new data network (e.g., a visiting PLMN). This makes it difficult for the AF to find an appropriate Edge Application Server for which the UE is directed to connect with for discovery or re-discovery. It will be appreciated that a DNAI is an operator defined identifier of a user plane access to one or more Data Networks at which specific applications can be found, for example, in support of Multi Access Edge Computing (MEC).

Conventionally, in home routed roaming scenarios, the 5GC is not equipped to select an appropriate target DNAI from a PLMN. The named inventors of this application have recognized that the 5GC could be better equipped to select an appropriate target DNAI from a PLMN. According to one or more embodiments described herein, notifications to the AF may be enhanced so that the AF has better information used to select an appropriate Edge Application Server for discovery or re-discovery. The named inventors of this application have also recognized that modules in data network core, such as the AF and a Session Management Function (SMF), could be better equipped to react to events leading to discovery or re-discovery of an edge application server.

The described embodiments provide one or more apparatuses in a data network core (e.g., a 5GC) that detect an event relating directly or indirectly to the UE or an Edge Application Server, and trigger a discovery or re-discovery process of an Edge Application Server that includes processing of a potential target DNAI, or a serving PLMN identifier (ID), or a target IP address of a target Edge Application Server, or a combination thereof.

In one embodiment, the AF is configured to influence the data network core so that a UE moving between a first data network and a second data network is served by an appropriate Edge Application Server. In another embodiment, the AF is configured to influence the data network so that a UE connecting to a data network is served by an appropriate Edge Application Server.

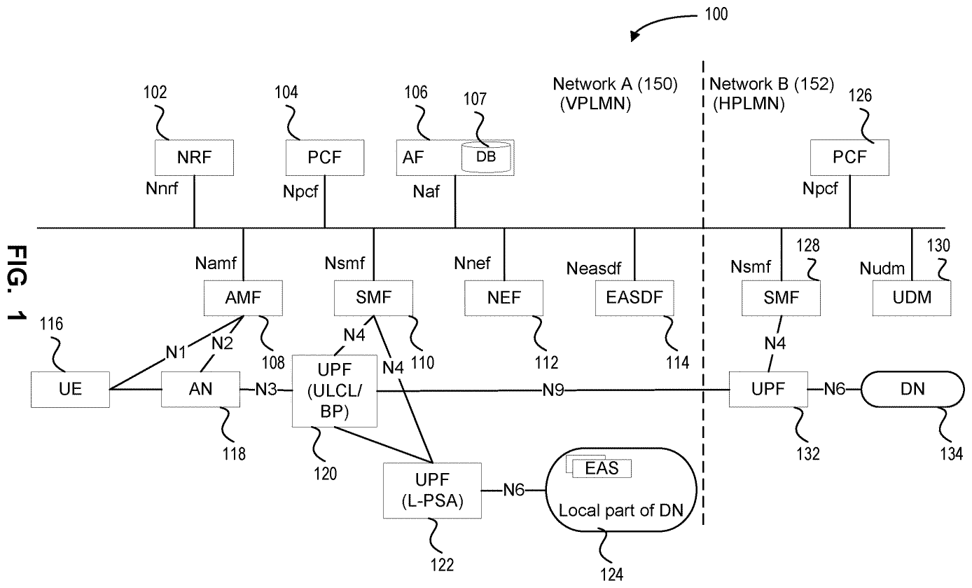

Referring now to FIG. 1, an illustration of an example mobile communication system 100 is provided. System 100 is an implementation of a 5GS, however the concepts described herein may be applicable in other networks similar to 5GS. FIGS. 6, 7, 8 and 9 illustrate the functions of the components of system 100 and the interfaces between them. The system 100 includes a Visiting PLMN (VPLMN) and a Home PLMN (HPLMN). More generally, there is a first network 152 and a second network 150. The system for one of the networks (e.g., the second network 150) includes: Network Repository Function (NRF) 102, Policy Control Function (PCF) 104, Application Function (AF) 106, Access and Mobility Management Function (AMF 108), Session Management Function (SMF) 110, Network Exposure Function (NEF) 112, Edge Application Server Discovery Function (EASDF) 114, User Equipment (UE) 116, Access Network (AN) 118, User Plane Function (UPF) 120 as Uplink Classifier (ULCL)/Branching Point (BP), UPF 122 as Local PDU Session Anchor (L-PSA), and one or more Edge Application Servers (EAS) 124 as part of the data network. The system for another one of the data networks (e.g., the first network 152) includes: a PCF 126, a SMF 128, a Unified Data Management (UDM) 130, a UPF 132, and the data network 134. The AF 106 includes a database 107 or, if the database 107 is external to the AF, the AF has access to the database 107. The database stores one or more EAS IP addresses associated with a given application service. Preferably, the database stores a plurality of EAS IP addresses associated with a given application service, and the AF 106 selects an EAS IP address from the plurality of EAS IP addresses for the UE 116 to connect with.

These network entities can data communicate with each other. For example, the AF 106 and the one or more SMFs 110, 128 can communicate with each other, including communicating event notifications with PLMN IDs or candidate DNAIs (or both) and messages with a source EAS IP address and a target EAS IP address.

The embodiment of the system in FIG. 1 show two data networks. However, in other embodiments for EAS selection, there is only one data network and the network entities shown in FIG. 1 can be used in these other embodiments.

It will be appreciated that the term “Function” as used in this context is drawn from the applicable 3GPP standard, and refers to an entity-physical or logical that performs the applicable function. The function may be provided by a physical or virtual machine or container. For example, Application Function 106 may be implemented in a physical machine or as a logical machine in a virtualization environment.

In 5GS and other communication networks, the functions of AF 106, SMFs 110 and 128, NEF 112, and other network entities may be provided in a variety of ways. In one example, some or all of the AF 106, SMFs 110 and 128, NEF 112, may be standalone physical computers. In another example, one or more of the AF 106, SMFs 110 and 128, NEF 112 may be virtual computers executed for example in a bare metal, native hypervisor virtualization environment such as VMWare ESXi™, or in an operating system-level virtualization environment using containers, e.g., Docker™ or Imctfy containers. In the case of virtualization, the underlying computer that executes the virtual machine or container may comprise one or more physical computers. In some cases, a single physical computer or group of physical computers may be configured to execute a plurality of virtual machines or containers, with the result that AF 106 (and other network entities) may be implemented anywhere within a network 110. Therefore, in some cases, AF 106 may be physically remote from the SMF 110 or 128, whereas in other cases AF 106 may be physically proximate to SMF 110 or 128, or even co-hosted on the same physical hardware.

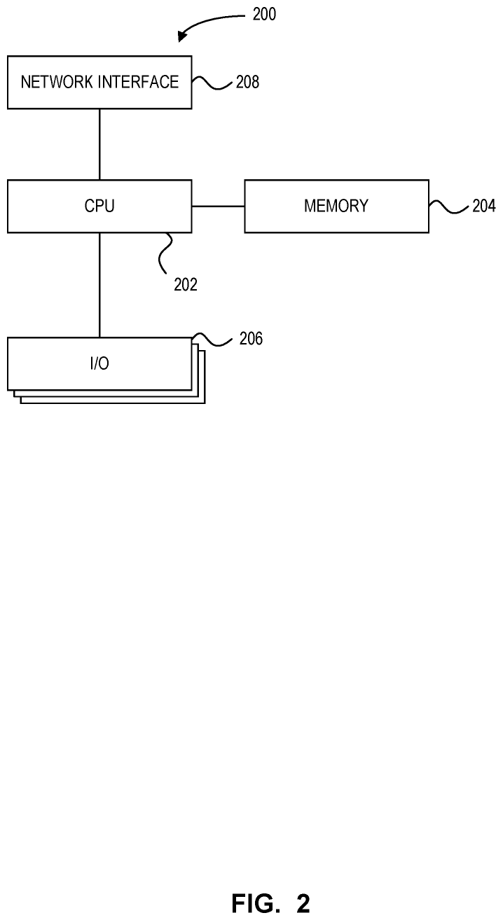

Referring now to FIG. 2, there is illustrated a simplified block diagram of a computer in accordance with at least some embodiments. Computer 200 is a simplified example of a computer, such as the UE 116, AF 106, SMF 110, SMF 128 as per FIG. 1, or, in the case of virtualization, of the underlying physical computer that executes the virtual machine or container. Computer 200 generally has at least one processor 202 operatively coupled to at least one memory 204 and a network communications interface 208. In some embodiment, the computer 200 includes an input/output device 206.

The at least one memory 204 includes a volatile memory that stores instructions executed or executable by processor 202, and input and output data used or generated during execution of the instructions. Memory 204 may also include non-volatile memory used to store input and/or output data along with program code containing the executable instructions.

Processor 202 may cause transmit or receive of data via a network communications interface 208, or may also transmit or receive data via any additional input/output device 206 as appropriate, or a combination thereof.

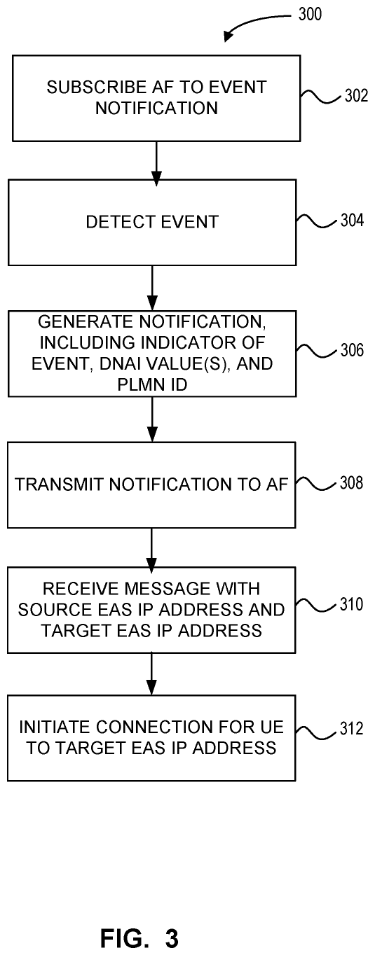

Referring to FIG. 3, an example embodiment is provided of instructions that are executable by a processor of a SMF. At 302, the SMF subscribes the AF to an event notification service, so that events will trigger notifications to be sent from the SMF to the AF. In an example embodiment, there is one event. In another example embodiment, there are multiple events that will trigger a notification.

At 304, the SMF detects an event associated with at least one of a UE and an Edge Application Server in a first data network. In an example embodiment, the UE is in data communication with the Edge Application Server over the first data network (e.g., a first PLMN) for accessing an application service.

At 306, the SMF generates a notification regarding the event. The notification may specify information, such as an indicator, about the event. In an embodiment, the notification further includes an ID of a serving data network. For example, this is the S-PLMN ID. In an example aspect, the notification is called Nsmf_EventExposure_Notify.

In a further example aspect, the notification further includes one or more DNAI values that are associated with the ID of the serving data network. These one or more DNAI values are candidate DNAIs that can be used by the AF for selecting an appropriate Edge Application Service. In a further example aspect, the one or more DNAI values and the ID of the serving data network is combined to disambiguate the DNAI values. In an example data format, the ID of the serving data network (e.g., a PLMN ID) is placed in front of a candidate DNAI value.

In an example aspect, the selection and reselection of the UPF for PDU session establishment, UE mobility or UE traffic offloading are performed by the SMF by considering UPF deployment scenarios such as centrally located UPF and distributed UPF located close to or at the Access Network site. The set of parameters used for the selection mechanism is deployment specific and controlled by the operator configuration. The UPF selection functionality in the SMF optionally utilizes the NRF to discover UPF instance(s). In this case, the SMF issues a request to the NRF that may include the following parameters: Data Network Name (DNN), Single-Network Slice Selection Assistance Information (S-NSSAI), SMF Area Identity, Access Traffic Steering, Switching & Splitting (ATSSS) steering capabilities. In its answer, the NRF provides the NF profile(s) that include(s) the IP address(es) or the Fully Qualified Domain Name (FQDN) of the N4 interface of corresponding UPF instance(s) to the SMF.

UPFs may be associated with an SMF Area Identity in the NRF. This allows limiting the SMF provisioning of UPF(s) using NRF to those UPF(s) associated with a certain SMF Area Identity. This can, for example, be used in the case that an SMF is only allowed to control UPF(s) configured in NRF as belonging to a certain SMF Area Identity.

The corresponding UPF instance(s) may be assigned with corresponding DNAIs and can be notified to the AF.

At 308, the SMF transmits the notification to the AF, either directly or via the NEF.

In an embodiment of FIG. 3, the serving data network is a different data network than the first data network. More particularly, the event comprises detecting that the mobile device has changed from the first data network to the different data network. This occurs, for example, when the mobile device is roaming between networks. For example, the event is a UE handover from a home PLMN to a visiting PLMN. In another example, the event is a UE handover from a first visiting PLMN to a second visiting PLMN. In another example, the event is a UE handover from different PLMNs that belong to a same mobile network operator.

In another embodiment in FIG. 3, the serving data network is the first data network. In a further example aspect, the event comprises detecting that the mobile device has disconnected and reconnected to the first data network.

It will be appreciated that other events can trigger the notification. For example, an event is related to the Edge Application Server with which the UE is initially connected. In another example, an event is a User Plane reconfiguration. In another example, the event is a DNAI change.

Continuing with FIG. 3, at 310, after the transmitting the notification, the SMF receives a message that includes a source EAS IP address and a target EAS IP address. The source EAS IP address is the IP address of the Edge Application Server with which the UE is currently connected or previously connected, for example, in a current data session or previous data session. The target EAS IP address is the IP address of the target Edge Application Server provided by the AF. In an example aspect, a plurality of target EAS IP addresses are provided in the message.

At 312, the SMF initiates a connection for the UE to data connect with the target EAS IP address. In an example aspect, the connection is part of a synchronization that includes redirecting the traffic of the UE via the source/target UPF/DNAI from the source EAS IP address to the target EAS IP address.

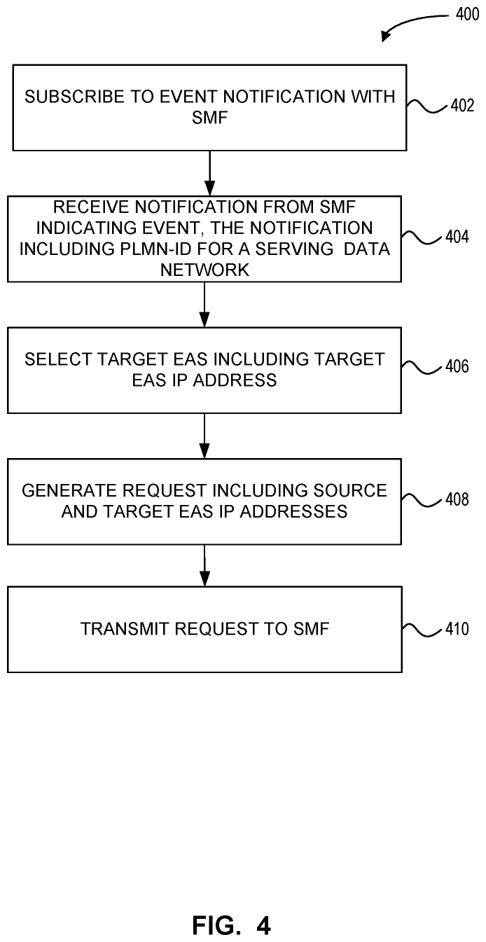

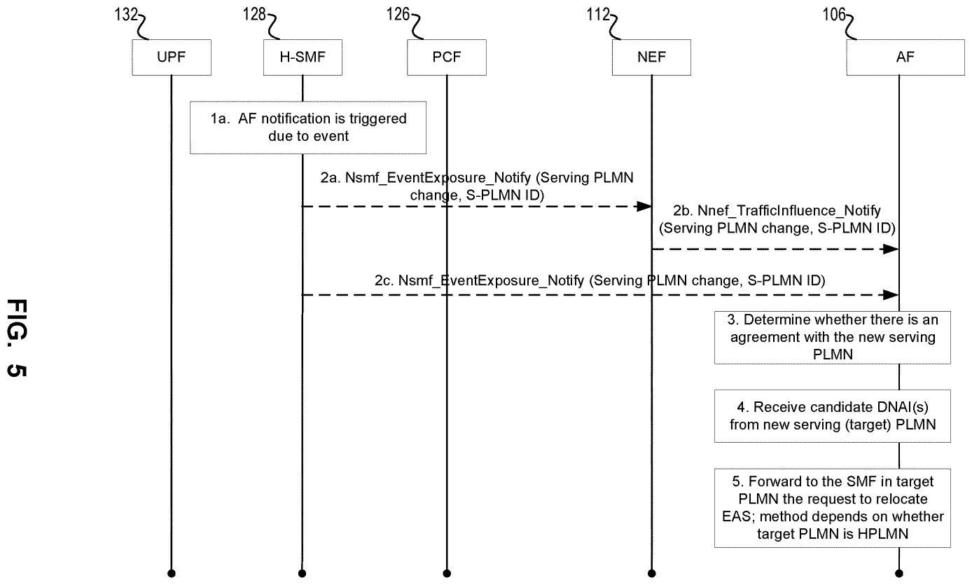

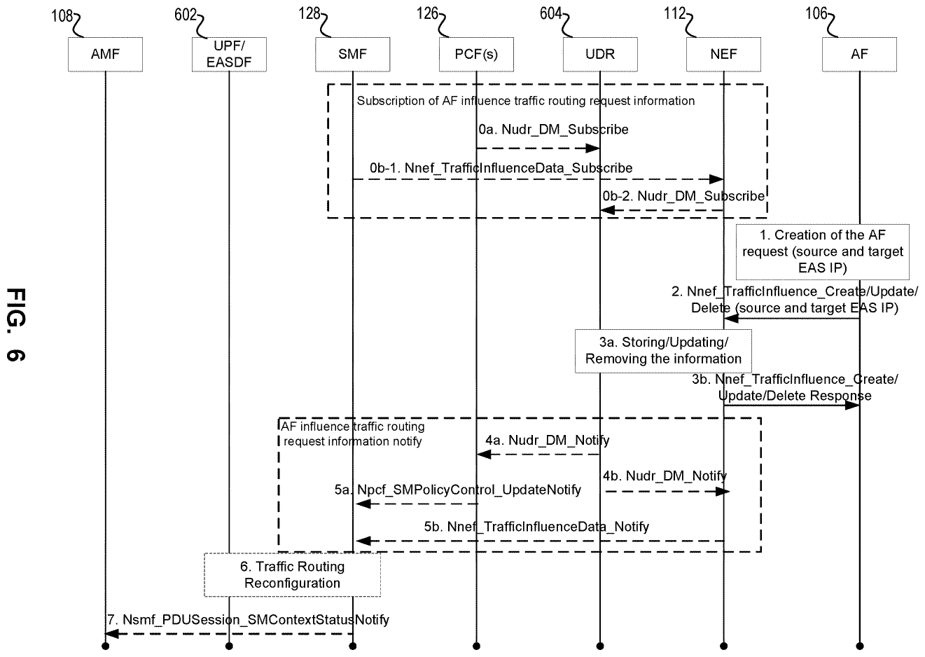

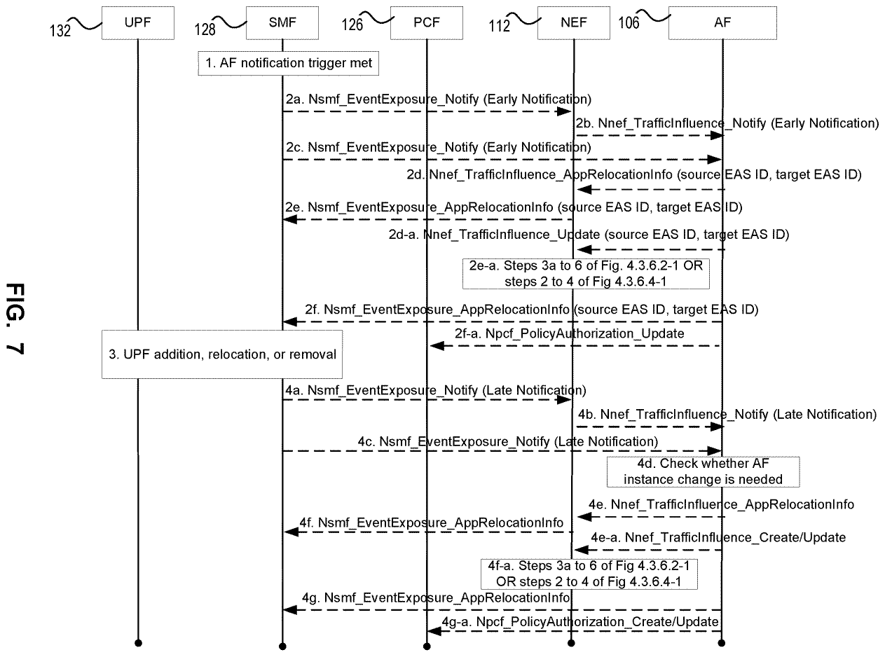

Referring now to FIG. 4, an example embodiment is provided of executable instructions 400 that are executable by a processor of an AF.

At 402, the AF subscribes to event notification with the SMF. As discussed above, the types of events can vary according to different embodiments.

At 404, the AF receives a notification from the SMF indicating an event has occurred. The notification further includes the ID of the serving data network. For example, the notification is identified as Nsmf_EventExposure_Notify and it includes the ID of the serving data network, identified as S-PLMN ID.

This notification, for example, may be the notification described at 306 in FIG. 3. The notification further includes one or more DNAI values that are associated with the ID of the serving data network. These one or more DNAI values are candidate DNAIs that can be used by the AF for selecting an appropriate Edge Application Service. In a further example aspect, the one or more DNAI values and the ID of the serving data network is combined to disambiguate the DNAI values. In an example data format, the ID of the serving data network (e.g., a PLMN ID) is placed in front of a candidate DNAI value.

At 406, after the receiving of the notification, the AF uses the ID of the serving data network to select one or more target Edge Application Servers including the one or more IP addresses of the one or more target Edge Application Servers. If both a DNAI value and the corresponding serving PLMN ID are provided, both are used to identify one or more target Edge Application Servers.

For example, the one or more target Edge Application Servers that are selected may be an Edge Application Server that is geographically closest or within the same geographical coverage of the serving PLMN.

In another example, an Edge Application Server that is associated with the DNAI and that is considered to have an acceptable amount of latency, is selected by the AF.

It will be appreciated that the AF may apply multiple processes to select one or more target Edge Application Servers.

In an example aspect, the AF accesses a database 107 that stores information about a plurality of Edge Application Servers including their corresponding IP addresses. The AF selects one or more target EAS IP addresses from the database.

At 408, the AF generates a message, for example a request, that includes a source EAS IP address and a target EAS IP address. The source EAS IP address and the target EAS IP address were discussed above with respect to 310 in FIG. 3.

At 410, the AF transmits the message to the SMF, either directly or via a NEF. It will be appreciated that the message is used to cause a data connection of the mobile device to connect to a target EAS IP address via the serving data network.

In the embodiment in FIG. 4, the serving data network is a different data network than the first data network. More particularly, the event comprises detecting that the mobile device has changed from the first data network to the different data network.

In another embodiment in FIG. 4, the serving data network is the first data network. In a further example aspect, the event comprises detecting that the mobile device has disconnected and reconnected to the first data network.

Referring now to FIG. 5, an example SMF notification procedure is provided.

At 1a in FIG. 5, an AF notification is triggered due to an event. In an example embodiment, in the case of HR-SBO (Home Routed Session Breakout), the detected event is that the UE is roaming to the serving network where the data offload is allowed for the user data connection.

At 2a in FIG. 5, a notification, such as Nsmf_EventExposure_Notifiy, which includes a Serving PLMN change indicator and Serving PLMN ID, is sent from a home SMF to the NEF, and the NEF transmits the same at 2b to the AF. Alternatively, the notification is transmitted directly to the AF at 2c in FIG. 5. The notification may contain a list of DNAI candidates in the serving PLMN.

At 3 in FIG. 5, the AF determines whether there is an agreement with the new serving PLMN.

At 4 in FIG. 5, the AF receives candidate DNAIs from the new serving PLMN. After the AF receives the candidate DNAIs in the new serving PLMN it builds an aggregated list of DNAIs from both the new serving PLMN and the home PLMN, the AF decides whether or not to initiate DNAI relocation. If so, the AF perform DNAI relocation at 5 in FIG. 5.

At 5 in FIG. 5, the AF forwards to the SMF in the new serving PLMN the request to relocate to a target EAS. The method of relocating may depend on whether the new serving PLMN is the home PLMN of the UE.

Referring now to FIG. 6, the procedure shown relates to 5 in FIG. 5.

At 0a, 0b-1, and 0b-2 in FIG. 6, operations are executed for subscription of the AF to influence traffic routing request information. This includes the PCF 126 sending a subscribe message to the Unified Data Repository (UDR) 604, the SMF 128 sending a subscribe message to the NEF 12, and the NEF sending a subscribe message to the UDR 604.

At 1 in FIG. 6, the AF creates a request that includes a source EAS IP address and a target EAS IP address. At 2 in FIG. 6, the AF provides this request to the NEF. In particular, the example Nnef_TrafficInluence_Create/Update/Delete message includes the source EAS IP address and the target EAS IP address. This information is included in 3a and 3b.

Responsive to receiving the AF triggered EAS relocation indication and the target EAS ID, the SMF may configure the PSA UPF to the new EAS IP address.

Operations in 4a, 4b, 5a, 5b, and 6 in FIG. 6 relate to traffic routing and traffic reconfiguration, and 7 in FIG. 6 relates to status notification. More particularly, these operations 4a, 4b, 5a, 5b, 6 and 7 are performed as defined in 3GPP TS 23.502.

Preferably the AF signals the AF-TrafficInfluenceCreate/Update to the PLMN where the source DNAI resides as it does not require the SMF to retrieve the old/source DNAI from the remote/partner SMF in the other PLMN. If the AF signals the AF-TrafficInfluenceCreate/Update to the PLMN where the target DNAI resides, the SMF to host the target DNAI is to retrieve the old/source DNAI from the from the remote/partner SMF in the other PLMN.

A particular example embodiment of FIG. 6 is provided in FIG. 7, specific to when the subscription: notification is using traffic influence related subscription described in section 4.3.6.3 “Notification of User Plane Management Events” in 3GPP TS 23.502.

FIG. 7 shows a high level view of the H-SMF notification to the AF using SMF event for Early notification.

At 1, 2a, 2b and 2c in FIG. 7, the SMF provides a target DNAI, PLMN ID, or one or more candidate DNAI(s). This is also described in section 4.3.6.3 of 3GPP TS 23.502.

At 2d in FIG. 7, the AF decides to relocate the source EAS to a target EAS IP address, for example due to the target DNAI. Since this is a visiting PLMN of the UE HR-SBO (determined based on the notification in the embodiment shown in FIG. 5), the AF provides target EAS IP address as well as a source (or previous) EAS IP address since the visiting SMF is unaware of source EAS IP address. The source and the target EAS IP addresses are used by the SMF so that it can do EAS relocation. For example, EAS relocation is performed according to the procedure specified in section 6.3.3 of 3GPP TS 23.548. It also includes controlling UPF to do Network Address Translating (NATing) from source EAS IP address used by the UE to the target EAS IP address.

At 2e in FIG. 7, the NEF in turn forwards the received information from AF in 2d to the SMF.

At 2d-a in FIG. 7, the AF needs to provide the same information via Nnef-TrafficInfluence_Update. That is, the AF includes source EAS IP address as well as the target EAS IP address.

At 2f in FIG. 7, the AF may send information directly to the SMF using Nsmf_EventExposure_ApprelocaitonInfo. In this case, the AF also includes the source EAS IP address as well as target EAS IP address.

At 2f-a to 4g-a in FIG. 7, these operations are the same as in described in section 4.3.6.3 of 3GPP TS 23.502.

It will be appreciated that there are other scenarios in which the AF can influence the routing of traffic based on a selected target EAS ID.

In an example embodiment, there is a scenario specific to a PDU session establishment with HR-SBO. The event is an occurrence that includes an initial DNAI/EAS that is in the visiting PLMN. The home PLMN notifies the PLMN ID of the home PLMN and associated DNAI's to the AF initially connected to the visiting PLMN.

In another example embodiment, there is a scenario specific to a handover from a non-roaming scenario to a HR-SBO scenario. In this case the initial DNAI/EAS was in the non roaming home PLMN, and after the handover the DNAI/EAS will be in the visiting PLMN as part of the existing handover procedure, based on the PDU session for HR-SBO. In this case the home PLMN is to notify the PLMN ID and associated DNAI's of the PLMN to the AF.

In another example embodiment, there is a handover from a HR-SBO scenario to a non-roaming scenario. In this case the current DNAI/EAS is in the visiting PLMN and after the handover only the home PLMN is left in the non-roaming scenario. That means the visiting PLMN notifies that the visiting PLMN is removed and the visting PLMN and associated DNAI are terminated in the visiting PLMN, and not available anymore.

In another example embodiment, there is a handover from a HR-SBO scenario with a first visiting PLMN (VPLMN1) to the handover from HR-SBO scenario with a second visiting PLMN (VPLMN2). The home PLMN may or may not need to notify anything as the PLMN ID is the same however if the associated DNAI's may have changed the notification is used.

In an example aspect, an AF triggered EAS re-location with inter data network mobility related with HR SBO is made possible with one or more of the embodiments described herein.

In another example aspect, since the AF gets information about the availability of the further DNAI's in the potential target PLMN, also herein called new serving PLMN or serving PLMN, the AF has a global view for the selection of desired target DNAI (and EAS IP addresses) from both PLMNs.

In another example aspect, the one or more embodiments provided herein provide separation of the handover procedure and the EAS re-selection procedure.

In another example aspect, the one or more embodiments provided herein include the PLMN ID coded into the DNAI, or combined together. This makes the DNAI globally unique for easing DNAI selection.

Additional example embodiments are provided below:

Clause 1: An apparatus comprising means for: receiving a notification from a session management apparatus in a source data network, the notification comprising an indicator of an event and an ID of a serving data network; after the receiving of the notification, generating a request comprising a source IP address of a source edge application computing server and a target IP address of a target edge application computing server, the source IP address associated with the source data network and the target IP address associated with the serving data network; and transmitting the request, the request configured to cause a data connection of user equipment to connect to the target IP address via the serving data network.

Clause 2: The apparatus of clause 1, wherein the serving data network is different from the source data network.

Clause 3: The apparatus of clause 2, wherein the event comprises a detection of the user equipment having changed from the source data network to the serving data network.

Clause 4: The apparatus of clause 1, wherein the serving data network is the source data network.

Clause 5: The apparatus of clause 4, wherein the event comprises a detection of the user equipment having disconnected from the serving data network and reconnected to the serving data network.

Clause 6: The apparatus of claim 5, wherein the event further comprises a determination that a data offload is allowed for a user data connection in the serving data network.

Clause 7: The apparatus of any one of clauses 1 to 6, wherein the means further performs: after the receiving the notification and before the generating the request, selecting the target IP address of the target edge application computing server.

Clause 8: The apparatus of clause 7, wherein the notification further comprises one or more candidate Data Network Access Identifier (DNAI) values associated with and combined with the ID of the serving data network, the one or more candidate DNAI values being available for the user equipment in the serving data network, and wherein the means further performs: accessing a database that stores a plurality of IP addresses reachable from the serving data network and corresponding to a plurality of edge application computing servers, the plurality of IP addresses including the target IP address; and, wherein the selecting comprises obtaining the target IP address from the database.

Clause 9: The apparatus of clause 8, wherein the means further performs: subscribing to the serving data network to receive the notification which comprises the one or more candidate DNAI values.

Clause 10: The apparatus of clause 8 or 9, wherein the means further performs: determining one or more candidate IP addresses corresponding to one or more candidate edge application computing servers, the one or more candidate IP addresses corresponding to the one or more candidate DNAI values; and selecting the target IP address from the one or more candidate IP addresses according to one or more parameters, wherein the one or more candidate IP addresses are a subset of the plurality of IP addresses in the database.

Clause 11: The apparatus of clause 10, wherein the one or more parameters comprise a distance between a location of the target IP address and a location of the serving data network.

Clause 12: The apparatus of any one of clauses 8 to 11, wherein the database is stored on the apparatus.

Clause 13: The apparatus of any one of clauses 1 to 12, wherein the means further performs: prior to the receiving the notification, subscribing to the session management apparatus in the source data network to receive one or more notifications in response to detecting the event.

Clause 14: The apparatus of any one of clauses 1 to 7, wherein the notification further comprises one or more Data Network Access Identifier (DNAI) values associated with and combined with the ID of the serving data network.

Clause 15: An apparatus comprising means for: at least one processor; and at least one memory storing instructions, the at least one memory and the instructions configured to, with the at least one processor, cause the apparatus at least to perform: detecting an event associated with a user equipment in a source data network; responsive to detecting the event, generating a notification, the notification comprising an indicator associated with the event and an ID of a serving data network; and transmitting the notification to an application apparatus in the source data network.

Clause 16: The apparatus of clause 15, wherein the notification further comprises an ID of the source data network.

Clause 17: The apparatus of clause 15 or 16, wherein the serving data network is different from the source data network.

Clause 18: The apparatus of clause 17, wherein the event comprises a detection of the user equipment having changed from the source data network to the serving data network.

Clause 19: The apparatus of clause 15 or 16, wherein the serving data network is the source data network.

Clause 20: The apparatus of clause 19, wherein the event comprises a detection of the user equipment having disconnected from the serving data network and reconnected to the serving data network.

Clause 21: The apparatus of any one of clauses 15 to 20, wherein the notification is sent after having checked that a data offload is allowed for a user data connection in the serving data network.

Clause 22: The apparatus of any one of clauses 15 to 21, wherein the notification further comprises one or more candidate Data Network Access Identifier (DNAI) values associated with and combined with the ID of the serving data network, the one or more candidate DNAI values being available for the user equipment in the serving data network

Clause 23: The apparatus of any one of clauses 15 to 21, wherein the notification further comprises one or more Data Network Access Identifier (DNAI) values associated with and combined with the ID of the serving data network.

Clause 24: The apparatus of any one of clauses 15 to 23, wherein the means further performs: after the transmitting the notification, receiving a message, the message configured to cause a data connection for a session serving an application of the user equipment to change from connecting via a source IP address of a source edge application computing server to connecting via a target IP address.

Clause 25: The apparatus of any one of clauses 15 to 24, wherein the means further performs: prior to the detecting the event, subscribing the application apparatus to receive one or more notifications for the event.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art.

The embodiments described herein may be implemented as a combination of hardware or software, as described above. Further, in some examples, one or more of the systems and methods described herein may be implemented in or as part of a distributed or cloud-based computing system having multiple computing components distributed across a computing network. The distributed or cloud-based computing system be a publicly accessible, distributed or cloud-based computing cluster, such as a computing cluster maintained by Microsoft Azure™, Amazon Web Services™, Google Cloud™, or another third-party provider.

Some aspects of the embodiments described herein may be implemented via software that is written in a high-level procedural language such as object-oriented programming language. Accordingly, the program code may be written in any suitable programming language such as Java, Python or Rust, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage.

Although embodiments have been described above with reference to the accompanying drawings, those of skill in the art will appreciate that variations and modifications may be made without departing from the scope thereof as defined by the appended claims.

1. An apparatus, comprising:
at least one processor; and
at least one memory storing instructions which, when executed by the at least one processor, cause the apparatus at least to perform:
receiving a notification from a session management apparatus in a source data network, the notification comprising an indicator of an event and an identifier (ID) of a serving data network, wherein the event comprises a determination that a data offload is allowed for a user data connection in the serving data network;
after the receiving of the notification, generating a request comprising a source internet protocol (IP) address of a source edge application computing server and a target IP address of a target edge application computing server, the source IP address associated with the source data network and the target IP address associated with the serving data network; and
transmitting the request, the request configured to cause a data connection of user equipment to connect to the target IP address via the serving data network.

2. The apparatus of claim 1, wherein the serving data network is different from the source data network.

3. The apparatus of claim 2, wherein the event comprises a detection of the user equipment having changed from being served by the source data network to being served by the serving data network.

4. The apparatus of claim 1, wherein the serving data network is the source data network.

5. The apparatus of claim 4, wherein the event comprises a detection of the user equipment having disconnected from the serving data network and reconnected to the serving data network.

6. (canceled)

7. The apparatus of claim 1, wherein the instructions, when executed by the at least one processor, further cause the apparatus at least to perform:
after the receiving the notification and before the generating the request, selecting the target IP address of the target edge application computing server.

8. The apparatus of claim 7, wherein the notification further comprises one or more candidate Data Network Access Identifier (DNAI) values associated with and combined with the ID of the serving data network, the one or more candidate DNAI values being available for the user equipment in the serving data network, and
wherein the instructions when executed by the at least one processor, further cause the apparatus at least to perform:
accessing a database that stores a plurality of IP addresses reachable from the serving data network and corresponding to a plurality of edge application computing servers, the plurality of IP addresses including the target IP address; and
wherein the selecting comprises obtaining the target IP address from the database.

9. The apparatus of claim 8, wherein the instructions, when executed by the at least one processor, further cause the apparatus at least to perform:
subscribing to the serving data network to receive the notification which comprises the one or more candidate DNAI values.

10. The apparatus of claim 8, wherein the instructions, when executed by the at least one processor, further cause the apparatus at least to perform:
determining one or more candidate IP addresses corresponding to one or more candidate edge application computing servers, the one or more candidate IP addresses corresponding to the one or more candidate DNAI values; and
selecting the target IP address from the one or more candidate IP addresses according to one or more parameters,
wherein the one or more candidate IP addresses are a subset of the plurality of IP addresses in the database.

11. The apparatus of claim 10, wherein the one or more parameters comprise a distance between a location of the target edge application computing server associated with the target IP address and a location of the serving data network.

12. (canceled)

13. The apparatus of claim 1, wherein the instructions, when executed by the at least one processor, further cause the apparatus at least to perform:
prior to the receiving the notification, subscribing to the session management apparatus in the source data network to receive one or more notifications of a detection of the event by the session management apparatus.

14. (canceled)

15. An apparatus, comprising:
at least one processor; and
at least one memory storing instructions which, when executed by, the at least one processor, cause the apparatus at least to perform:
detecting an event associated with a user equipment in a source data network;
based on detecting the event, generating a notification, the notification comprising an indicator associated with the event and an identifier (ID) of a serving data network; and
transmitting the notification to an application apparatus in the source data network, wherein the transmitting the notification is after having determined that a data offload is allowed for a user data connection in the serving data network.

16. The apparatus of claim 15, wherein the notification further comprises an ID of the source data network.

17. The apparatus of claim 15, wherein the serving data network is different from the source data network.

18. The apparatus of claim 17, wherein the event comprises a detection of the user equipment having changed from being served by the source data network to being served by the serving data network.

19. The apparatus of claim 15, wherein the serving data network is the source data network.

20. (canceled)

21. The apparatus of claim 15, wherein the event comprises a detection of the user equipment roaming to the serving network, a data offload being allowed for a user data connection in the serving data network.

22. The apparatus of claim 15, wherein the notification further comprises one or more candidate Data Network Access Identifier (DNAI) values associated with and combined with the ID of the serving data network, the one or more candidate DNAI values being available for the user equipment in the serving data network.

23. (canceled)

24. The apparatus of claim 15, wherein the instructions, when executed by the at least one processor, further cause the apparatus at least to perform:
after the transmitting the notification, receiving a message, the message configured to cause a data connection for a session serving an application of the user equipment to change from connecting via a source IP address of a source edge application computing server to connecting via a target IP address.

25. The apparatus of claim 15, wherein the instructions, when executed by the at least one processor, further cause the apparatus at least to perform:
prior to the detecting the event, subscribing the application apparatus to receive one or more notifications for the event, the one or more notifications comprising the notification.
